(19) United States
(12) Patent Application Publication
(10) Pub. No.: US 2018/0304371 A1
(43) Pub. Date: Oct. 25, 2018

(54) COMPOSITE METALLIC AND CERAMIC GAS TURBINE ENGINE BLADE

(71) Applicant: Siemens Energy, Inc., Orlando, FL (US)

(72) Inventors: David J. Wiebe, Orlando, FL (US); Evan C. Landrum, Charlotte, NC (US)

(21) Appl. No.: 15/769,948

(22) PCT Filed: Oct. 29, 2015
(86) PCT No.: PCT/US2015/057945

§ 371 Date: Apr. 20, 2018

Related U.S. Application Data
(63) Continuation of application No. PCT/US2015/057936, filed on Oct. 29, 2015.

(51) Int. Cl. B22F 5/04; B22F 3/105; B22F 7/06; B23K 15/00; B23K 26/342; B23P 6/00; F01D 5/00; F01D 5/14; F01D 5/20; F01D 5/28

(52) U.S. Cl. CPC B22F 5/04; B22F 3/1055; B22F 7/062; B23K 15/0086; B23K 15/0093; B23K 26/342; B23K 2201/001; F01D 5/005; F01D 5/147; F01D 5/20; F01D 5/282; F01D 5/284; B23P 6/002

(57) ABSTRACT

Composite metallic-ceramic construction blades for gas turbine engine compressor or turbine sections. A ceramic splice component, such as a squealer or other blade tip, or leading edge, mechanically interlocks with a metallic blade body, including a superalloy blade body. Respective interlocking mechanical joint portions of the ceramic splice component and metallic blade body are subsequently held in an interlocked position by a separately applied and independent metallic retainer member. Methods for manufacture of such composite blades are also useful for repair or retrofitting of non-composite, metallic blades.

### STATEMENT REGARDING FEDERALLY SPONSORED RESEARCH

Development for this invention was supported in part by Contract No. DE-FE0023955, awarded by the United States Department of Energy. Accordingly, the United States Government may have certain rights in this invention.

### PRIORITY CLAIM AND CROSS-REFERENCE TO RELATED APPLICATIONS

This application incorporates by reference in its entirety, and claims priority to copending International Application entitled “COMPOSITE GAS TURBINE ENGINE BLADE WITH INTERLOCKING COMPONENTS ADDITIVE MANUFACTURING FORMED RETAINER”, Docket 2015P21916WO, filed concurrently with this application, and assigned serial number ______.

### TECHNICAL FIELD

The invention relates to composite construction blades for gas turbine engine compressor or turbine sections. More particularly, the invention relates to composite construction gas turbine engine blades, where metallic and ceramic blade components are joined to each other by interlocking mechanical joints that are subsequently held in an interlocked position by a separately applied and independent metallic retainer member.

### BACKGROUND

Industrial gas turbine engines employ rotating metallic blades in their respective compressor and turbine sections. Often, turbines are formed from unistructural castings of homogenous material. Turbine blades in the turbine section are exposed to high temperature combustion gas, and potential foreign object damage (FOD) from particles entrained within the combustion gas, and are often constructed of superalloy materials, such as CM 247, IN 939 or PWA 1480 superalloys. Blade tips may contact and rub an opposed circumferential abradable surface formed within the engine casing. During engine operational service, combustion gas exposure, FOD, and blade tip rubbing can erode blade surfaces, even those constructed of superalloy materials. Worn surfaces are repaired, or blades are replaced, during scheduled service outages.

Cast blade repair methods to rebuild and restore worn surfaces to their original specification dimensional profiles include common welding or laser additive welding to build up worn material, in order to restore original structural strength specifications to an acceptable level. However, structural repair welding processes can induce cracks in metallic blade material, especially in superalloy material. Alternatively, structural repairs are accomplished by removing worn blade material and inserting a mechanically interlocking splice component of the same or similar material strength properties. The splice component is typically retained in its interlocking position by application of a plurality of weld tacks or beads—or in some applications a braze joint—that are less likely to induce cracks within the metallic blade.

While the prevalent method for forming turbine section blades has been by unistructural blade casting, composite blades have also been formed by joining of metal sub components. In some composite blades, ceramic sub components, such as blade leading edge surfaces, have been incorporated into the blade. Ceramic surfaces in some applications offer higher temperature operation and greater wear resistance than comparable metallic surfaces, even compared to superalloy materials. Given dissimilar material properties, ceramic components are not welded directly to metallic blade bodies. Rather, they have been captured within the blade body during the metallic blade casting process, wherein the solidified blade body material retains mating surfaces of the ceramic component. Accordingly, it has not been practical to repair or retrofit existing metallic blade castings by adding ceramic inserts after the original blade body casting process.

### SUMMARY OF INVENTION

Exemplary embodiments described herein facilitate fabrication of composite metal-ceramic or composite metal-metal gas turbine engine blades by mechanically joining components, such as a metallic blade body and a splice component by interlocking respective mating portions to a locked position. The mating joint is held in locked position by a metallic retaining member that is attached to the blade. The retaining member is a separate independent component that is coupled to the interlocking joint portions of the blade body and splice component, and blocks subsequent joint separation. In some embodiments, the retaining member is formed in place by applying and affixing a sequential-layer material addition by an additive manufacturing method, such as by a laser sintering or laser welding fabrication process.

In some embodiments described herein, a composite metallic-ceramic construction blade for gas turbine engine compressor or turbine sections is fabricated. In such fabrication, a ceramic splice component, such as a squealer or other blade tip, or leading edge, mechanically interlocks with a metallic blade body, including a superalloy blade body. The respective mechanical joint portions are subsequently held in an interlocked position by a separately applied and independent metallic retainer member. Methods for manufacture of such composite blades are also useful for repair or retrofitting of non-composite, metallic blades.

In some embodiments described herein, a composite metallic-ceramic, or metallic-metallic construction blade for gas turbine engine compressor or turbine sections is fabricated. In such fabrication, a splice component (metallic or ceramic), such as a squealer or other blade tip, or leading edge, mechanically interlocks with a metallic blade body, including a superalloy blade body. The respective mechanical joints portions are subsequently held in an interlocked position by a separately formed and applied, independent metallic retainer member. The retainer member is formed by a sequential-layer material addition, additive manufacturing method. These methods are also useful for repair or retrofitting of non-composite, metallic blades tip caps, leading edges, or other damaged structure.

Exemplary embodiments of the invention feature a composite turbine blade comprising a metallic blade body; a ceramic splice component that is selectively coupled to or decoupled from the blade body; and a mechanically interlocking joint. The interlocking joint has a first mating portion coupled to the blade body and a mating second portion coupled to the ceramic splice component. The joint first and second mating portions selectively interlock in a locked positon, so that the blade body and splice component are coupled to each other. The turbine blade also has a separate and independent metallic retainer member, which is coupled to the turbine blade external the previously interlocked first and second joint mating portions. The retainer member blocks subsequent interlocking joint decoupling.

Other exemplary embodiments of the invention feature a method for manufacturing a composite turbine blade. In this method, a metallic blade body and a ceramic splice component are provided. The ceramic splice component is selectively coupled to or decoupled from the blade body, by a mechanically interlocking joint. The joint has a first mating portion coupled to the blade body and a mating second portion coupled to the ceramic splice component. The metallic blade body and the ceramic splice components are coupled together by mating the first and second joint portions to a locked position. Then, a separate and independent metallic retainer member is affixed to the turbine blade, external the previously interlocked first and second joint mating portions, for blocking subsequent interlocking joint decoupling.

Additional exemplary embodiments of the invention feature a method for repairing or retrofitting a superalloy turbine blade tip. In this method an existing turbine blade tip is removed from a turbine blade body. An excavated recess is then formed in the blade body, whose profile is defined by the remaining blade body as a first mating portion of a mechanically interlocking joint. A replacement ceramic blade tip splice component is provided, which has a second mating portion of a mechanically interlocking joint that is selectively coupled or decoupled from the first joint portion. The metallic blade body and splice component are then coupled to each other, by mating the first and second joint portions to a locked position. Thereafter, a separate and independent metallic retainer member is affixed to the turbine blade, external the previously interlocked first and second joint mating portions. The retainer member blocks subsequent interlocking joint decoupling.

The respective features of the exemplary embodiments of the invention that are described herein may be applied jointly or severally in any combination or sub-combination.

### BRIEF DESCRIPTION OF DRAWINGS

The exemplary embodiments are further described in the following detailed description in conjunction with the accompanying drawings, in which:

FIG. 1 is a perspective view of a turbine section composite blade for a gas turbine engine, including a mechanically interlocked metallic blade body and squealer tip splice component that are retained in their respective interlocked positions by a metallic retainer member, which are assembled in accordance with an exemplary embodiment;

FIG. 2 is an enlarged, detailed perspective view of the mechanically interlocked blade body, splice component splice component and retainer member appearing in the boxed portion 2 of FIG. 1;

FIG. 3 is an exploded view of the mechanically interlocked blade body, squealer tip splice component and retainer member of FIG. 1;

FIG. 4 is a cross sectional elevational view, taken along 4-4 of FIG. 2;

FIG. 5 is a top plan view of a composite blade embodiment, including a mechanically interlocked blade body and squealer tip splice component, with blade platform-mounted retainer member, which are assembled in accordance with an exemplary embodiment;

FIG. 6 is a cross sectional elevational view, taken along 6-6 of FIG. 6;

FIG. 7 is a top plan view of a composite blade embodiment, including another embodiment of a mechanically interlocked blade body and squealer tip splice component, with blade body circumferentially-mounted retainer member, which are assembled in accordance with an exemplary embodiment;

FIG. 8 is a cross sectional elevational view, taken along 8-8 of FIG. 7;

FIG. 9 is an alternative embodiment of FIG. 8, wherein the circumferentially-mounted retaining member has a triangular cross section, and the mating squealer tip splice component interface has a complimentary, matching ramped profile;

FIG. 10 is a top plan view of a composite blade embodiment, including another embodiment of a mechanically interlocked blade body and squealer tip splice component, with blade end cap retainer member, which are assembled in accordance with an exemplary embodiment;

FIG. 11 is a cross sectional elevational view, taken along 11-11 of FIG. 10;

FIG. 12 is a top plan view of a composite blade embodiment, including another embodiment of a dovetail-type, mechanically interlocked blade body and a segmented squealer tip splice component, with a circumferentially-mounted, band-type retainer member, which are assembled in accordance with an exemplary embodiment;

FIG. 13 is a cross sectional elevational view, taken along 13-13 of FIG. 12;

FIG. 14 is a cross sectional elevational view, taken along 14-14 of FIG. 12;

FIG. 15 is a schematic elevational view of turbine section composite blade for a gas turbine engine, including a mechanically interlocked metallic blade body and squealer tip splice component that are retained in their respective interlocked positions by a key-type metallic retainer member that engages with a mating retaining groove formed within the squealer tip splice component, with the key then affixed to pillar- or pin-type projections formed in the blade body, which are assembled in accordance with an exemplary embodiment;

FIG. 16 is a plan view of the end cap of the composite turbine blade of FIG. 15;

FIG. 17 is a detailed view of the end cap of FIG. 16;

FIG. 18 is a cross sectional elevational view, taken along 18-18 of FIG. 17;

FIG. 19 is a cross sectional elevational view, taken along 19-19 of FIG. 17;

FIG. 20 is a detailed plan view of a blade body and end cap, similar to FIG. 17, showing an alternative key-type metallic retainer member that engages with a mating aperture formed within the squealer tip splice component, with the key then affixed to pillar- or pin-type projections formed in the blade body, which are assembled in accordance with an exemplary embodiment;

FIG. 21 is a schematic elevational view of a composite turbine section composite blade for a gas turbine engine, including a mechanically interlocked metallic blade body and leading edge splice component, which are assembled in accordance with an exemplary embodiment; and

FIG. 22 is a partial cross sectional plan view, taken along 22-22 of FIG. 21.

To facilitate understanding, identical reference numerals have been used, where possible, to designate identical elements that are common to the figures. Any reference designation “XX/YY” indicated that the associated lead line is directed to both of the elements XX and YY. The figures are not drawn to scale.

### DESCRIPTION OF EMBODIMENTS

Exemplary embodiments of the invention fabricate composite turbine blades, which include a metallic blade body and one or more splice components, such as blade squealer tips or other types of blade tip, as well as leading edge inserts. In some embodiments, the metallic blade body comprises a superalloy. In some embodiments, the splice components comprise ceramic material. In other embodiments, the splice components comprise metal. The splice component mechanically interlocks with the metallic blade body by mating first and second joint portions respectively formed in the blade body and splice component. The respective mechanical joint portions are subsequently held in an interlocked position by a separately formed and applied, independent metallic retainer member. In some embodiments, the retainer member is formed by a sequential-layer material addition, additive manufacturing method. The methods are also useful for repair or retrofitting of non-composite, metallic blades end caps, leading edges, or other damaged structure.

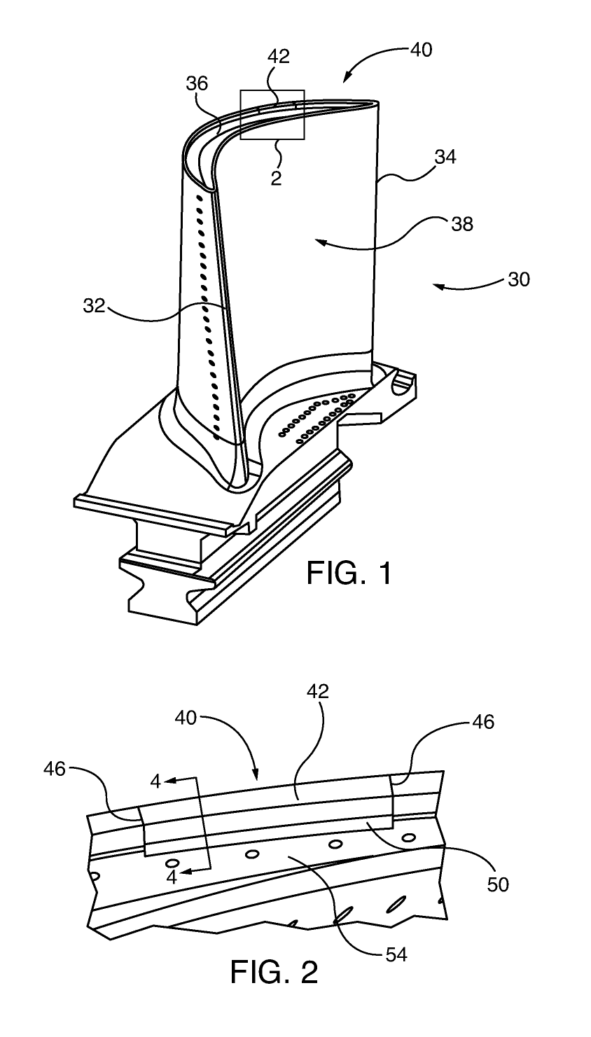

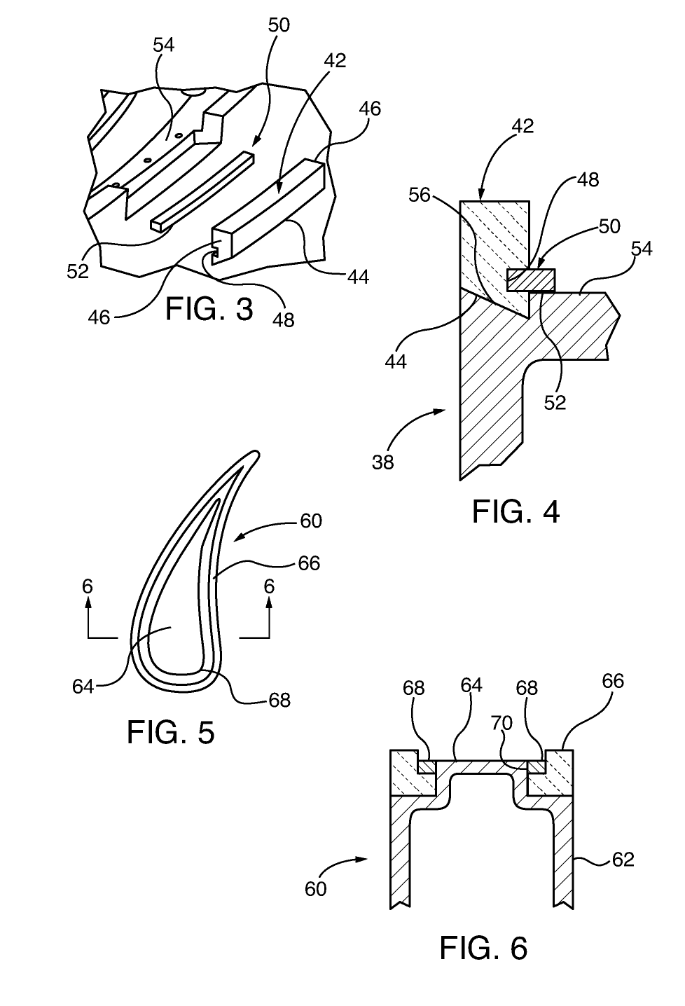

FIGS. 1-4 show a turbine section composite blade 30 for a gas turbine engine. The blade 30 has a leading edge 32, a trailing edge 34, a blade tip 36, and a metallic blade body 38, which is constructed of a known superalloy, such as CM 247, IN 939 or PWA 1480 superalloy. The blade tip 36 is a mechanically interlocked, separate squealer tip 40, which comprises a plurality of interlocking squealer tip splice components 42 that are coupled to the blade body 38. The mechanically interlocking joint between the splice components 42 and the blade body 38 comprises the ramped, opposed surfaces 44 and 56, respectively on the splice component 42 and on the blade body 38. Circumferentially, the sector-shaped splice components 42 interlock with each other by the ramped, opposed surface sidewalls 46, in a manner analogous to an arch and its keystone, preventing radial separation (i.e., horizontally in FIG. 4). Axial separation of the splice components 42 from the blade body 38 (i.e., vertically in FIG. 4) is prevented by blind recess retaining groove 48 formed in the splice component 42 capturing the retainer member 50. Retainer member 50 is a separate and independent metallic strip or biscuit that a continuous or discontinuous around the assembled squealer tip splice component 40, which is inserted into the retaining groove 48 after the splice components are engaged in interlocking, one-way insertion relationship with the blade body 38. Subsequently, the bottom surface 52 of the retainer member 50 is joined to the blade body platform 54 by weldment or braze joint. Alternatively, the retainer member 50 is formed by a sequential-layer material addition, additive manufacturing method to be described subsequently herein. The retainer member 50 is external the opposed, ramped surfaces 44, 46 and 56 that form the interlocking joints between the blade body 38 and the splice components 42. Thus, the retainer member 50 maintains the interlocking joints in their previously locked respective positions by blocking their decoupling.

An alternative embodiment composite turbine blade 60 is shown in FIGS. 5 and 6. The blade 60 has a metallic blade body 62, with a blade platform 64 forming part of the blade tip. A one-piece squealer tip 66 is inserted axially into mating, interlocking relationship with the blade platform 64, with interlocking joint portions restraining relative movement laterally and in the vertically down direction of FIG. 6. The squealer tip 66 L-shaped cross sectional profile captures metallic retainer member 68 in the circumferential recess formed between the former and the blade platform 64.

After the retainer member 68 is inserted into the recess, its inner circumference 70 is bonded to the blade platform 64 by weldment or braze joint. Alternatively, the retainer member 68 is formed in place by an additive manufacturing method, which bonds itself to the metallic blade platform 64. Thus, the retainer member 68 maintains the interlocking joints in their previously locked respective positions by blocking their decoupling. The squealer tip 66 is constructed of metal or ceramic material.

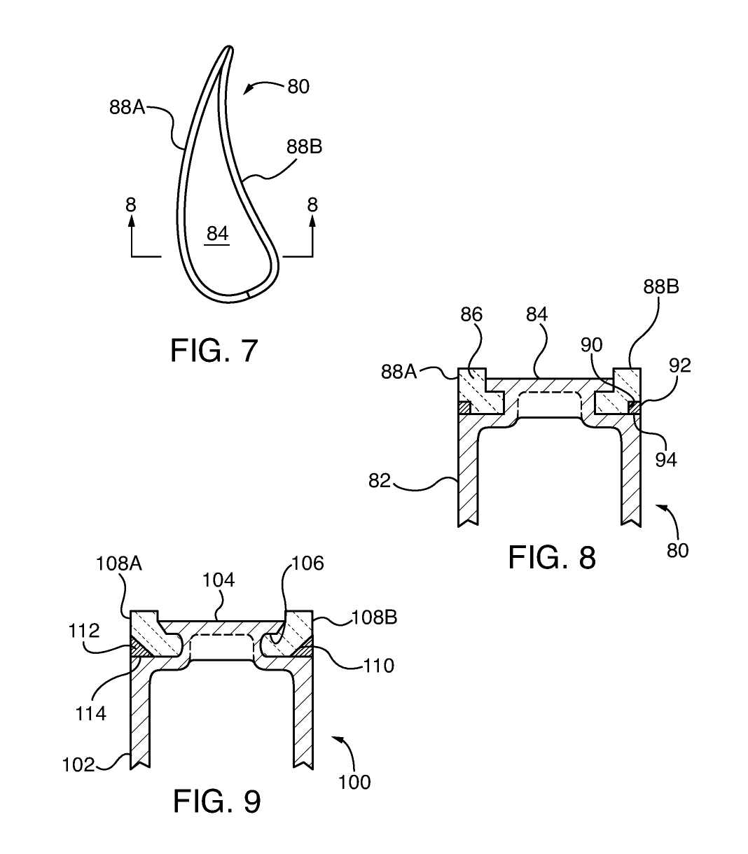

The alternative turbine blade 80 embodiment of FIGS. 7 and 8 includes a metallic blade body 82 and a two-piece, split squealer tip 88A and 88B. The blade body 82 has a blade platform 84, which defines a retaining flange 86. The L-shaped cross sectional profile squealer tip portions 88A and 88B are laterally inserted and captured within the retaining flange 86, which interlocks the respective components vertically/axially and radially/horizontally inwardly. The retaining groove 90 formed in the squealer tip portions 88A and 88B interlock with retainer member 92. The retainer member 92 forms a continuous or discontinuous circumferential band about the blade body 82 sidewall, preventing horizontal/outward separation of the squealer tip portions 88A and 88B. If the retainer member 92 is a continuous band, it is self-supporting, but optionally a bottom surface 94 or outside lateral surface of the band is joined to the blade body 82 by weldment or braze joint or the like. Alternatively, the retainer member 92 is formed in place by an additive manufacturing method, which optionally is bonded to the blade body 82. Thus, the retainer member 92 maintains the interlocking joints in their previously locked respective positions by blocking their decoupling.

FIG. 9 is an alternative construction split squealer tip composite turbine blade 100, which includes a blade body 102, blade platform 104 and retaining flange 106 that mates with split, two-piece squealer tip 108A and 108B to form the interlocking joint portions. The interlocking joint portions have a radiused profile. The squealer tip splice components define a ramped outer circumference 110, which mates with a triangular cross sectional profile retainer member 112, of similar construction to the retaining member 92 of the previously described blade 80 embodiment of FIGS. 7 and 8. The retainer member 112 forms a continuous or discontinuous circumferential band about the blade body 102 sidewall, preventing horizontal/outward separation of the squealer tip portions 108A and 108B. If the retainer member 112 is a continuous band, it is self-supporting, but optionally a bottom surface 114 or outside lateral surface of the band is joined to the blade body 102 by weldment or braze joint or the like. Alternatively, the retainer member 112 is formed in place by an additive manufacturing method, which optionally is bonded to the blade body 102. Thus, the retainer member 112 maintains the interlocking joints in their previously locked respective positions by blocking their decoupling.

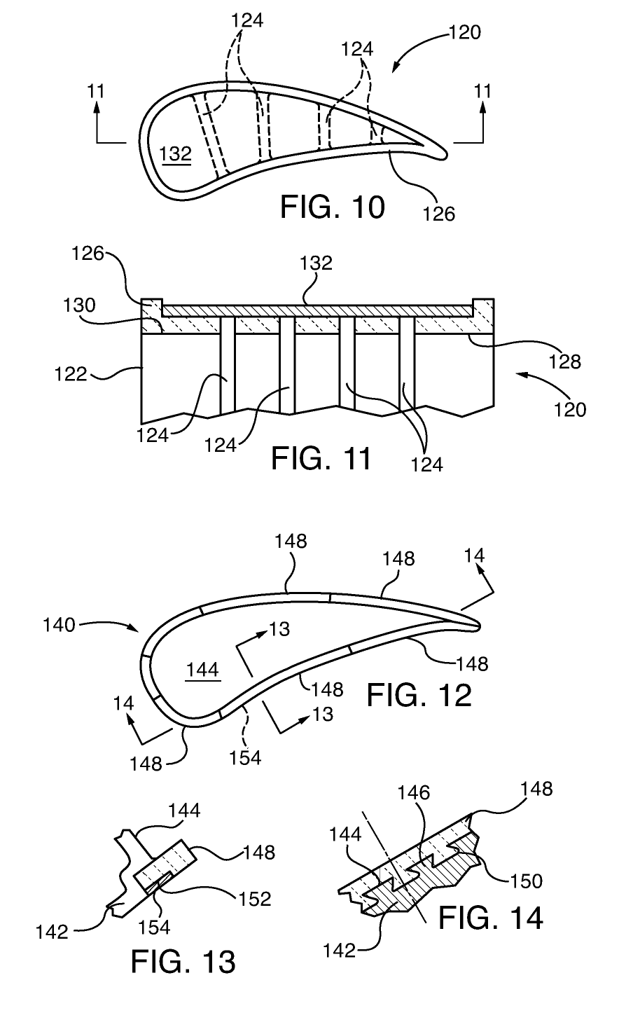

An alternative embodiment composite turbine blade 120 is shown in FIGS. 10 and 11. The blade 120 has a metallic blade body 122 and internal support pillars 124. A one-piece squealer tip splice component 126 has a bottom surface 128. During assembly, the squealer tip 126 is inserted axially into mating, interlocking relationship between its bottom surface 128 and the opposed support pillars 124 and the blade body outer wall peripheral mating surface 130. Tip cap 132 retainer member is inserted in nesting fashion within the squealer tip splice component 126. Subsequently the tip cap 132 bottom surface 128 is bonded to opposed surfaces of the support pillars 124 by weldment or brazed joint connection. The now rigidly coupled tip cap retainer member 132 prevents relative movement of the squealer tip splice component 126 and blade body 122. Alternatively, the tip cap retainer member 132 is formed in place by an additive manufacturing method, which bonds itself to the metallic support pillars 124. Thus, the retainer member 132 maintains the interlocking joints in their previously locked respective positions by blocking their decoupling. The squealer tip splice component 126 is constructed of metal or ceramic material.

FIGS. 12-14 are an alternative embodiment of a composite turbine blade 140, having a blade body 142, and segmented blade tip comprising splice components 148. As shown in FIG. 14, the blade body platform 144 defines dovetails 146 about its circumferential periphery, which form a first part of a mechanical interlocking joint portion. The splice components 148 have corresponding splice dovetails 150, which form a second part of a mechanical interlocking joint, when they are laterally inserted about the periphery of the blade platform 144. The mating dovetail portions 146 and 150 are locked into their interlocking position by engagement of the retaining groove 152 in the squealer splice components 148 with the circumferential retainer member band 154, as shown in FIG. 13. The retainer member band 154 is similar in concept to the retainer member (bands) 92 or 112 of respective FIGS. 8 and 9. The retainer member band 154 is bonded to the blade body 142 in abutting relationship with the splice component 148, blocking retraction of the splice component's dovetail portion 150 out of its interlocking relationship with the mating blade body dovetail portion 146. Alternatively, if the retainer member band 154 completely encircles the blade body 142 it does not need to be bonded to the blade body 142. In some embodiments, a completely encircling retainer member band 154 is formed from a single or multiple segments of metal sheet material, which is then profiled to match the corresponding blade body 142 outer peripheral profile. The profiled strip or strips is/are then joined at their ends to complete the retainer member band 154. Alternatively, the retainer member band 154 is formed in place by an additive manufacturing method. Thus, the retainer member band 154 maintains the interlocking joints in their previously locked respective positions by blocking their decoupling. The splice components 148 are constructed of metal or ceramic material.

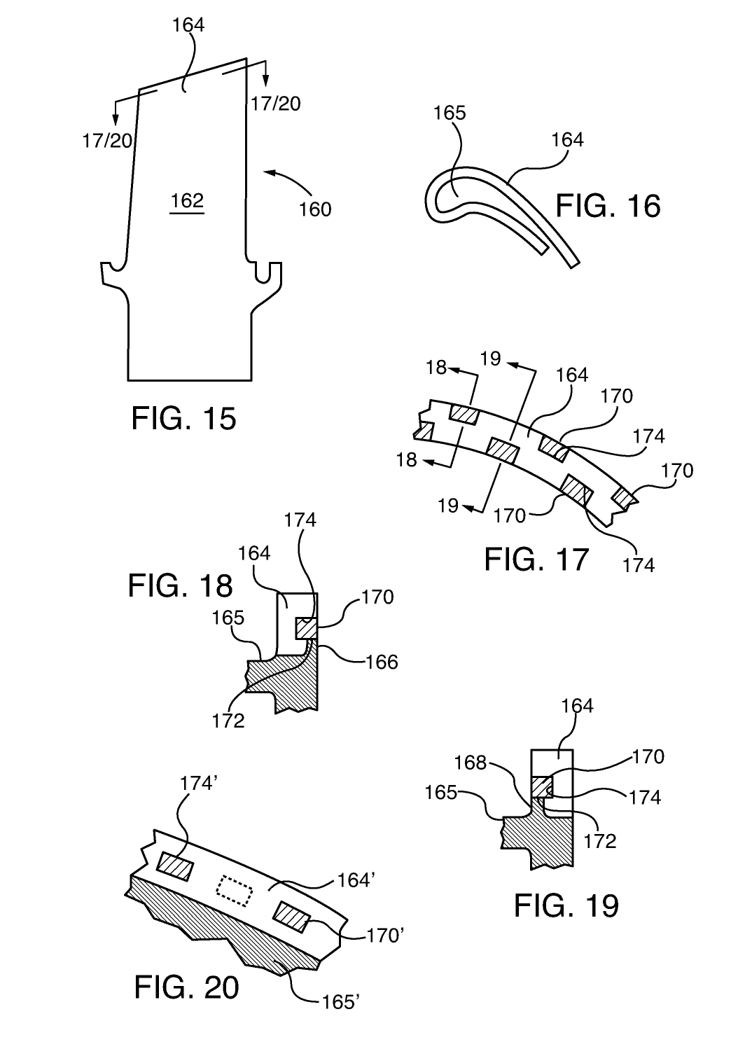

In the composite blade 160 embodiments of FIGS. 15-20, the blade body 162 mechanically interlocks with a one-piece squealer tip splice component 164 or 164′. The blade body blade platform 165 defines staggered, upwardly projecting, outboard 166 and inboard 168 pillars or pins that mate with corresponding recesses 174 or 174′ that are formed in the squealer tip splice component 164. A retaining member key 170 or 170′ is inserted in each recess 174, where it is subsequently bonded along its bottom surface 172 to a corresponding pin or pillar 166 or 168, such as by weld or braze joint. The joined pillar 166/168 and key 170 array forms a peripheral collet array around the splice component 164 inner and outer peripheries. Axial separation is also prevented by the collet array. In the alternative embodiment of FIG. 20, centrally oriented recesses 174′ are formed in the spice component 164′. Upwardly projecting pillars or pins formed in the blade platform 165′ are inserted into and circumferentially captured by respective recesses 174. Then the keys 170′ are bonded to the pillars as was done with respect to the corresponding keys 170 of FIG. 17. The keys 170′ define a laterally extending flange that prevents axial separation of the blade body 162 and the splice component 164′. Alternatively, the retainer member keys 170 and/or 170′ are formed in place by an additive manufacturing method. Thus, the retainer member keys 170 or 170′ maintain the interlocking joints in their previously locked respective positions by blocking their decoupling. The splice components 164 and 164′ are constructed of metal or ceramic material. While single-piece squealer tip splice components 164 and 164′ are shown in the figures, in an alternative embodiment the splice component comprises a plurality of segmented squealer tip splice components, similar to those of FIGS. 1, 7 and 12.

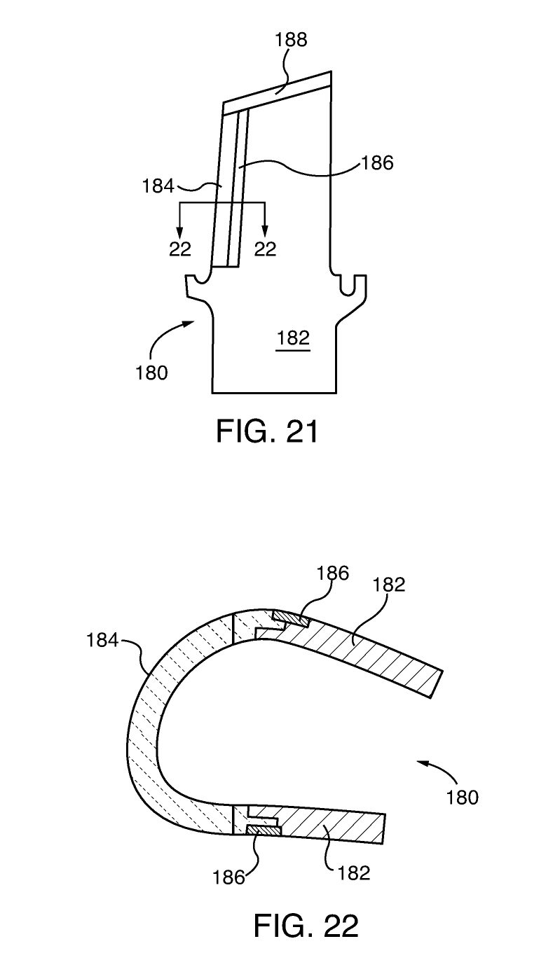

FIGS. 21 and 22 are a composite blade 180 embodiment, in which the metallic blade body 182 mates with an interlocking blade leading edge splice component or insert 184. A retaining member 186 is coupled to the blade body 182, preventing blade body 182 concave pressure side/convex suction side lateral separation from the leading edge insert 184. Forward and axial separation are blocked by a one-piece or segmented blade tip 188, which in some embodiments is constructed similar to those of FIG. 1, 5, 10, or 15.

As previously noted, in exemplary embodiments, the retaining member that maintains the blade body and splice component interlocking joint portions in their respective locked positions is separately formed as an independent metallic structure, an applied standard weld bead or braze joint, or a formed in place additive manufacture metallic component. Additive manufacture methods include, by way of non-limiting example, any method that incorporates a powder bed or direct energy deposition process involving granular powder or wire source of feed material, along with sequential layering of the feed material into a fabricated metallic component by electron-beam, laser cladding, direct metal laser sintering or selective laser melting, sheet lamination, binder jetting, ultrasonic or hybrid processing (additive/subtractive manufacturing processing with milling/machining capability integrated with deposition process). The feed material in some embodiments is powdered superalloy. In some embodiments, the retainer member is not bonded to the splice component, which is advantageous where the splice component comprises a non-metallic material, such as a ceramic material.

The composite blade structures and methods for manufacture of such blades are suitable for manufacture of new composite blades or for retrofitting of existing non-composite new or reconditioned blades. In the case of reconditioned blades, damaged portions of a previously in-service blade are removed and replaced with splice components, thereby converting that blade to a composite blade. Alternatively a previously in-service composite blade having the interlocking blade body and splice components of the present invention can be repaired by removing a worn splice component and replacing it with a new or reconditioned splice component.

Composited blade embodiments described herein are manufactured by providing a metallic blade body, a splice component, such as a squealer-type blade tip, that is selectively coupled to or decoupled from the blade body, and a mechanically interlocking joint. The joint first portion is in the blade body and a mating second portion is in the splice component. The first and second mating joint portions are coupled to a locked position. Subsequently, a separate and independent metallic retainer member is affixed to the turbine blade, for maintaining the mated first and second joint portions in their locked position by blocking their decoupling. The retaining member, as previously described, is applied by attachment of a pre-formed structural member, an applied weld or braze joint, or by additive manufacture. In some composite blade embodiments that incorporate a ceramic splice component, the retainer member is not joined to the ceramic component, but in some embodiments is joined to a metallic portion of the blade or blade body.

In the case of a retrofitted or repaired existing non-composite blade or blade casting, such as when removing and repairing a turbine blade tip, such as a squealer tip, the existing tip is removed. An excavated recess is formed in the remaining metallic blade body whose profile is a first portion of a mechanically interlocking joint that corresponds to and mates with a second portion of the interlocking joint defined by the replacement splice component blade tip. The first and second joint portions are coupled to their locked position. Then the retaining member is affixed to the blade, which blocks decoupling of the joint back to an unlocked state.

As in previous examples the retaining member is a separate structure that is pre-formed and affixed to the blade or formed in place as a weld bead, a braze joint or a sequential layer application by an additive manufacturing method. In some embodiments, the sequential layer application is performed by orienting the previously locked position, respective joint portions of the turbine blade and splice component in bed of granular metallic feed material, and fusing melting or sintering the feed material, layer by layer to form the retainer member. In some embodiments, the additive applied retainer member comprises a circumferential, homogeneous, unistructural band circumscribing the blade body and applied over the previously locked position first and second mated joint portions, such as the retainer member band 154 of FIGS. 12-14. In other embodiments, the additive applied retainer member comprises a blade tip cap, such as the tip cap 132 of FIGS. 10 and 11, that is applied over the previously locked position first and second mated joint portions. In other embodiments, the additive applied retainer member comprises a pillar or pin formed in place within an aperture or recess defined by the splice component and/or the blade body, such as the key 170 or 170′ of FIGS. 17-20.

Although various embodiments that incorporate the invention have been shown and described in detail herein, others can readily devise many other varied embodiments that still incorporate the claimed invention. The invention is not limited in its application to the exemplary embodiment details of construction and the arrangement of components set forth in the description or illustrated in the drawings. The invention is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “supported”, and “coupled” and variations thereof are used broadly and encompass direct and indirect mountings, connections, supports, and couplings.

1. A composite turbine blade comprising:
a metallic blade body;
a ceramic splice component that is selectively coupled to or decoupled from the blade body;
a mechanically interlocking joint having a first mating portion associated with the blade body and a second mating portion associated with the ceramic splice component, the joint first and second mating portions interlocked in a locked positon; and
a discrete metallic retainer member positioned against at least one of the first or second mating portions which maintains the joint first and second mating portions in the locked position.

2. The composite turbine blade of claim 1, the ceramic splice component comprising at least a portion of either a turbine blade tip or a turbine blade leading edge.

3. The composite turbine blade of claim 1, comprising plurality of interlocking ceramic splice components collectively forming a turbine blade tip.

4. The composite turbine blade of claim 3, the ceramic splice component forming at least a portion of the blade tip, its interlocking second joint portion inserted into and interlocking with a ramped recess of the first mating portion proximate a tip portion of the blade body, the retainer member bonded to the blade body in abutting relationship with the ceramic splice component, blocking retraction of the splice component out of its interlocking relationship with the ramped recess.

5. The composite turbine blade of claim 1, the ceramic splice component forming at least a portion of the blade tip, its interlocking second mating portion including a dovetail portion inserted into and interlocking with a mating dovetail portion of the first mating portion that is formed in the metallic blade body proximate a tip portion thereof, the retainer member bonded to the blade body in abutting relationship with the ceramic splice component, blocking retraction of the splice component dovetail portion out of its interlocking relationship with the mating blade body dovetail portion.

6. The composite turbine blade of claim 1, the ceramic splice component forming at least a portion of the blade tip, its interlocking second mating portion including a recess interlocking with a mating projection of the first mating portion that is formed in the metallic blade body proximate a tip portion thereof, the retainer member coupled to the mating projection of the first mating portion, capturing the splice component its interlocking relationship with first joint portion.

7. The composite turbine blade of claim 1, the first joint portion formed directly in the metallic blade body and the second joint portion formed directly in the ceramic splice component.

8. The composite turbine blade of claim 1, the first and second joint portions having mating profiles that locally vary, and only allow unidirectional insertion and withdrawal of the ceramic splice component during coupling or uncoupling thereof.

9. The composite turbine blade of claim 1, the first mating portion comprising at least one slot passing partially through the blade body.

10. The composite turbine blade of claim 9, a slot cross-sectional profile of the at least one slot varying locally allowing only unidirectional insertion and withdrawal of the ceramic splice component during coupling or uncoupling thereof.

11. The composite turbine blade of claim 1, one of the first or second mating portions comprising a blind recess formed therein, for engagement with a mating projecting portion formed in the other of the first or second joint portions.

12. The composite turbine blade of claim 1, one of the first or second mating portions comprising a blind recess formed therein, for engagement with a mating projecting portion formed in the retainer member.

13. The composite turbine blade of claim 1, the retainer member bonded to the blade body or the first mating portion by a welded or a brazed joint, but not bonded to the ceramic splice component.

14. The composite turbine blade of claim 1, the retainer member comprising a weld bead or a formed-in place, additively manufactured metallic component, wherein the retainer member is not bonded to the ceramic splice component.

15. A method for manufacturing a composite turbine blade comprising:
providing a metallic blade body and a ceramic splice component that is selectively coupled to or decoupled from the blade body;
coupling the metallic blade body and ceramic splice components by mating a first mating portion associated with the blade body and a second mating portion associated with the ceramic splice component to a locked position; and
and affixing a discrete metallic retainer member against at least one of the first or second mating portions to maintain the joint first and second mating portions in the locked position.

16. The method of claim 15, the first and second mating portions having mating profiles that only allow unidirectional insertion and withdrawal into and out of the locked position, and the coupling performed by mating the respective first and second joint portions in a single insertion direction.

17. The method of claim 15, wherein the affixing comprises forming a weld bead, or a braze joint, or an additively manufactured metallic component that is not bonded to the ceramic splice component.

18. A method for repairing or retrofitting a superalloy turbine blade tip, comprising:
removing an existing turbine blade tip of a turbine blade body and forming therein an excavated recess whose profile is defined by the remaining blade body as a first mating portion of a mechanically interlocking joint;
providing a replacement ceramic blade tip splice component defining a second mating portion of the mechanically interlocking joint;
coupling the turbine blade body and splice component to each other by mating the first and second mating portions to a locked position; and
affixing a discrete metallic retainer member against at least one of the first or second mating portions to maintain the first and second mating portions in the locked position.

19. The method of claim 18, the first and second mating portions having mating profiles that only allow unidirectional insertion and withdrawal into and out of locked position.

20. The method of claim 18, wherein the affixing of the retainer member further comprises forming a weld bead, or a braze joint, or an additively manufactured metallic component that is not bonded to the ceramic splice component.
